(19) United States
(12) Patent Application Publication
(10) Pub. No.: US 2026/0170887 A1
(43) Pub. Date: Jun. 18, 2026

(54) VEHICLE STATUS PREDICTION SYSTEM AND METHOD

(71) Applicant: INDUSTRIAL TECHNOLOGY RESEARCH INSTITUTE, Hsinchu (TW)

(72) Inventors: Bo-Yu CHEN, Hsinchu City (TW); Yu-Hung HSUEH, Zhubei City (TW)

(73) Assignee: INDUSTRIAL TECHNOLOGY RESEARCH INSTITUTE, Hsinchu (TW)

(21) Appl. No.: 18/982,876

(22) Filed: Dec. 16, 2024

(51) Int. Cl. G07C 5/08; B60L 53/66; B60W 50/00

(52) U.S. Cl. CPC G07C 5/08; B60L 53/66; B60W 50/0097

(57) ABSTRACT

The present disclosure provides a vehicle status prediction system and method. The vehicle status prediction method is adapted to a vehicle installed with at least one sensor, and the method, performed by a processing device, includes: obtaining at least one set of raw driving data from the at least one sensor, extracting at least one target sub-data set from the at least one set of raw driving data based on observation indicators, clustering the at least one target sub-data set to generate a cluster label, and using a pre-trained model according to the cluster label to predict the at least one set of raw driving data to generate a vehicle status prediction result.

### BACKGROUND

### 1. Technical Field

This disclosure relates to a vehicle status prediction system and method.

### 2. Related Art

With the net-zero carbon emission strategy, the number of electric vehicles (EVs) continues to grow, making the demand for vehicle diagnostics and maintenance increasingly urgent. Existing diagnostic methods rely on specialized equipment and manual intervention. If routine maintenance or obvious issues are only addressed after they are discovered, potential failures may not be detected early enough for early warnings. Therefore, as the number of EVs continues to rise, the importance of rapid diagnostics and anomaly warnings is also increasing.

### SUMMARY

According to one or more embodiments of this disclosure, a vehicle status prediction method, adapted to a vehicle installed with at least one sensor, is performed by a processing device and includes: obtaining at least one set of raw driving data from the at least one sensor; extracting at least one target sub-data set from the at least one set of raw driving data according to a plurality of observation indicators; clustering the at least one target sub-data set to generate a cluster label; and performing prediction on the at least one set of raw driving data according to the cluster label using a pre-trained model to generate a status prediction result of the vehicle.

According to one or more embodiments of this disclosure, a vehicle status prediction system, adapted to a vehicle installed with at least one sensor, includes: a memory device and a processing device. The memory device is configured to store a pre-trained model. The processing device is connected to the memory device and configured to perform: obtaining at least one set of raw driving data from the at least one sensor; extracting at least one target sub-data set from the at least one set of raw driving data according to a plurality of observation indicators; clustering the at least one target sub-data set to generate a cluster label; and performing prediction on the at least one set of raw driving data according to the cluster label using the pre-trained model to generate a status prediction result of the vehicle.

### BRIEF DESCRIPTION OF THE DRAWINGS

FIG. 1 is a block diagram illustrating a vehicle status prediction system according to an embodiment of the present disclosure.

FIG. 2 is a flowchart illustrating a vehicle status prediction method according to an embodiment of the present disclosure.

FIG. 3(a) is a curve diagram showing temperatures of coolant corresponding to different vehicle manufacturers according to an embodiment of the present disclosure.

FIG. 3(b) is a schematic diagram illustrating clusters according to an embodiment of the present disclosure.

FIG. 4 is a flowchart illustrating generating a status prediction result of the vehicle in the vehicle status prediction method according to an embodiment of the present disclosure.

FIG. 5 is a flowchart illustrating generating a pre-trained model in the vehicle status prediction method according to an embodiment of the present disclosure.

### DETAILED DESCRIPTION

In the following detailed description, for purposes of explanation, numerous specific details are set forth in order to provide a thorough understanding of the disclosed embodiments. According to the description, claims and the drawings disclosed in the specification, one skilled in the art may easily understand the concepts and features of the present invention. The following embodiments further illustrate various aspects of the present invention, but are not meant to limit the scope of the present invention.

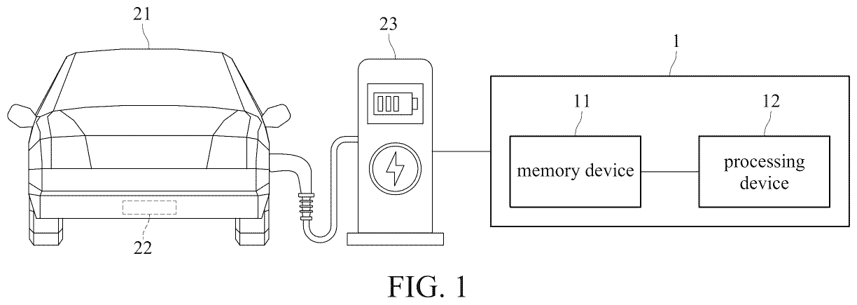

Please refer to FIG. 1, wherein FIG. 1 is a block diagram illustrating a vehicle status prediction system according to an embodiment of the present disclosure. As shown in FIG. 1, the vehicle status prediction system 1 includes a memory device 11 and a processing device 12. The memory device 11 is electrically connected to or in communication connection with the processing device 12. The vehicle status prediction system 1 may be implemented as a remote server. The vehicle status prediction system 1 is adapted to a vehicle 21, and the vehicle 21 is installed with at least one sensor 22. FIG. 1 illustrates one sensor 22, but the number of the sensor 22 may also be more than one. Further, the sensor 22 is illustrated as disposed at the bottom of the vehicle 21 in FIG. 1, but the sensor 22 may also be installed at different positions of the vehicle 21. One sensor 22 may be configured to generate one set of raw driving data. The sensor 22 may be configured to perform sensing to generate the raw driving data of the vehicle 21. The raw driving data may include one or more of a driving speed, a throttle acceleration, a motor torque, a gear position, a coolant temperature, a braking intensity, a battery charge level, a battery temperature, a battery charging status, a state of charge (SOC), a battery discharge current, and a battery discharge voltage. The vehicle 21 may be connected to a charging station 23 to receive power from the charging station 23. Further, the vehicle 21 may further output the raw driving data generated by the sensor 22 to the processing device 12 through the charging station 23.

The memory device 11 is configured to store a pre-trained model. The pre-trained model may include a transfer learning model and a multitask learning model. The memory device 11 may include one or more memories, the memory may be one or more of a non-volatile memory (NVM), such as read only memory (ROM), flash memory or non-volatile random-access memory (NVRAM) etc.

The processing device 12 is configured to predict the status of the vehicle 21 by using the raw driving data from the sensor 22 and the pre-trained model stored by the memory device 11. The processing device 12 may include one or more processors, the processor is, for example, central processing unit (CPU), graphics processing unit (GPU), microcontroller, programmable logic controller (PLC), or other processors with signal processing capabilities.

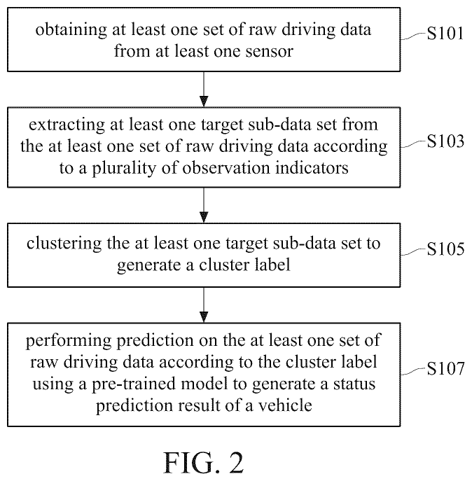

Please refer to FIG. 1 and FIG. 2, wherein FIG. 2 is a flowchart illustrating a vehicle status prediction method according to an embodiment of the present disclosure. As shown in FIG. 2, the vehicle status prediction method includes: step S101: obtaining at least one set of raw driving data from the at least one sensor; step S103: extracting at least one target sub-data set from the at least one set of raw driving data according to a plurality of observation indicators; step S105: clustering the at least one target sub-data set to generate a cluster label; and step S107: performing prediction on the at least one set of raw driving data according to the cluster label using a pre-trained model to generate a status prediction result of a vehicle.

In step S101, the processing device 12 obtains at least one set of raw driving data from the sensor 22. As described above, one sensor 22 may generate one set of raw driving data. Take coolant temperature for example, one set of raw driving data may include temperature variations of the coolant temperature in a specified time interval. In an embodiment, the vehicle 21 is an electric vehicle, and the raw driving data generated by the sensor 22 may be transmitted to the remote processing device 12 through the charging station 23 when the vehicle 21 is connected to the charging station 23 to be charged. Further, the raw driving data generated by the sensor 22 may be transmitted to a vehicle control unit (VCU) (not illustrated in the drawings) of the vehicle 21, and then transmitted from the VCU to the charging station 23, for the charging station 23 to transmit the raw driving data to the processing device 12. In addition, the vehicle status prediction system 1 may further include a data center (not illustrated in the drawings), and the raw driving data may be further transmitted to the memory device 11 or the data center connected to the processing device 12 for data storage. Accordingly, the VCU of the vehicle 21 does not need to constantly transmit the raw driving data to the remote processing device 12, thereby reducing the burden of data transmission of the VCU.

In step S103, the processing device 12 extracts the at least one target sub-data set from the raw driving data according to the observation indicator. In the example of the raw driving data being coolant temperature, the observation indicators may include a highest temperature indicator, an average temperature indicator and a temperature standard deviation indicator. When the processing device 12 obtains one set of raw driving data, the corresponding target sub-data set may include a highest temperature of the coolant, an average temperature of the coolant and a temperature standard deviation of the coolant. In the example of the sets of raw driving data being driving speed and motor torque, the observation indicators corresponding to the driving speed may include maximum driving speed indicator and an average driving speed indicator, and the observation indicators corresponding to the motor torque may include maximum motor torque indicator and average motor torque indicator. When the processing device 12 obtains the sets of raw driving data, the target sub-data set corresponding to the driving speed may include maximum driving speed and average driving speed, and the target sub-data set corresponding to the motor torque may include maximum motor torque and average motor torque. The coolant temperature, driving speed and motor torque described above are examples, the present disclosure is not limited thereto. In addition, step S103 may further include removing noise from the raw driving data, and said extracting the target sub-data set from the raw driving data may be performed after the noise is removed.

In step S105, the processing device 12 performs clustering on the at least one target sub-data set to determine a target cluster, among a plurality of existing clusters, as corresponding to the target sub-data set, and a label of the target cluster is served as the cluster label of the target sub-data set. In an embodiment, step S105 may include executing density-based spatial clustering of application with noise (DBSCAN) algorithm on the at least one target sub-data set to generate the cluster label. In the embodiment of one set of raw driving data, the at least one target sub-data set is one target sub-data set, and the processing device 12 may perform clustering on the target sub-data set to determine that the target sub-data set corresponds to one target cluster among the existing clusters, and the processing device 12 may use the label of the target cluster as the cluster label of the target sub-data set. In the embodiment of the sensor 22 being a plurality of sensors and the raw driving data being a plurality of sets of raw driving data, the at least one target sub-data set is a plurality of target sub-data sets, and the processing device 12 may perform clustering on the target sub-data sets to determine that the target sub-data sets correspond to one target cluster among the existing clusters, and the processing device 12 may use the label of the target cluster as the cluster label of the target sub-data set.

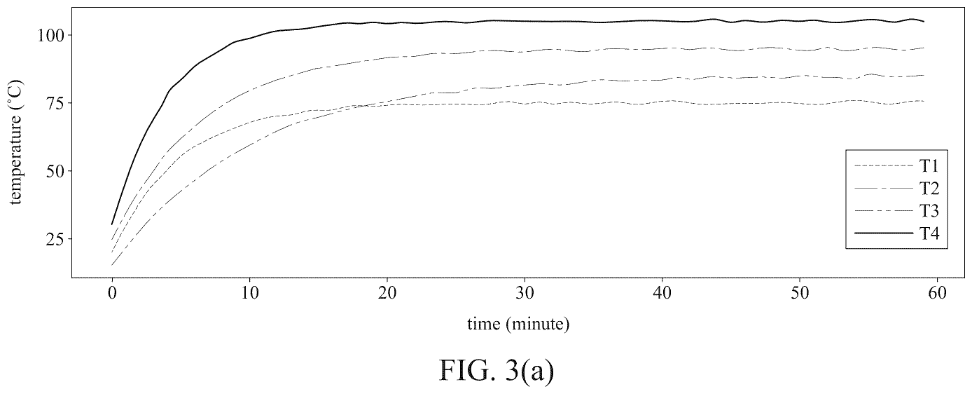

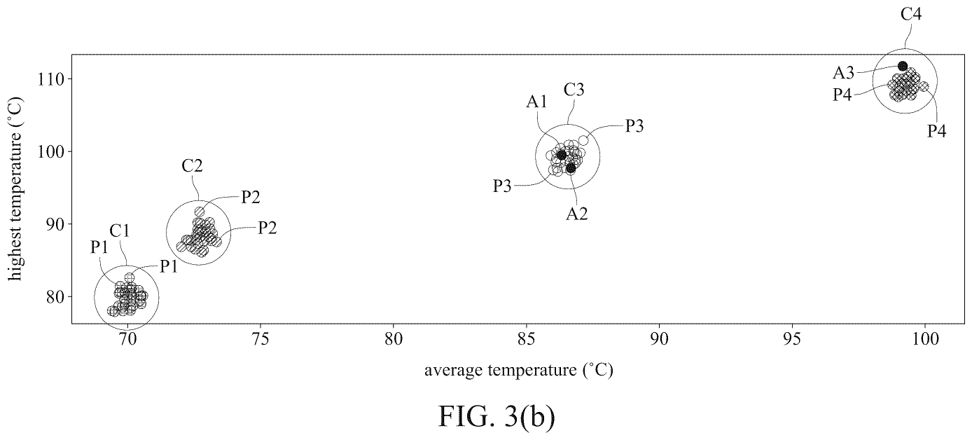

Please refer to FIG. 3(a), wherein FIG. 3(a) is a curve diagram showing temperatures of coolant corresponding to different vehicle manufacturers according to an embodiment of the present disclosure. Curves T1 to T4 respectively represent raw driving data of the coolant temperature variations over time for different vehicle manufacturers. As shown in FIG. 3(a), the curves T1 to T4 are different from each other. The processing device 12 may perform clustering on the curves T1 to T4 according to the observation indicators in advance to generate the existing clusters of the curves T1 to T4. In other embodiments, the clustering performed in advance may also be performed by another processing device, the present disclosure is not limited thereto.

Please refer to FIG. 3(b), wherein FIG. 3(b) is a schematic diagram illustrating clusters according to an embodiment of the present disclosure. FIG. 3(b) shows four existing clusters C1 to C4 generated by performing clustering on the curves T1 to T4 shown in FIG. 3(a). The existing cluster C1 includes a plurality of sub-data sets P1, the existing cluster C2 includes a plurality of sub-data sets P2, the existing cluster C3 includes a plurality of sub-data sets P3, and the existing cluster C4 includes a plurality of sub-data sets P4. In FIG. 3(b), the circles used to represent the existing clusters C1 to C4 are only illustrated for better understanding of the relationships between the existing clusters and the sub-data sets, the circles are not intended to limit the distribution ranges of the existing clusters. Take coolant temperature for example, when the target sub-data set includes an average temperature of 70° C. and a highest temperature of 80° C., the target sub-data set may be categorized to the existing cluster C1 and assigned with the cluster label of the existing cluster C1. Further, continued from the example of FIG. 3(a), the cluster label of the existing cluster C1 may indicate that the target sub-data set corresponds to the vehicle manufacturer of curve T1.

It should be noted that FIG. 3(a) and FIG. 3(b) show the example of coolant temperature using different vehicle manufacturers as the cluster labels, the present disclosure does not limit the types of the cluster labels and is not limited to the application of coolant temperature; and FIG. 3(b) exemplarily shows temperature of two-dimensional data, but the data dimensions of the target sub-data set and the existing clusters may also be higher than two, the present disclosure is not limited thereto.

In step S107, the processing device 12 performs prediction on the raw driving data according to the cluster label using the pre-trained model stored by the memory device 11 to generate the status prediction result of the vehicle. Further, the processing device 12 may output the status prediction result to an in-vehicle display and/or user's personal device to immediately notify the user whether there is abnormal situation with the vehicle. Further, the processing device 12 may output the status prediction result and/or an abnormal notification corresponding to the status prediction result to the in-vehicle display and/or the user's personal device through the charging station 23.

For example, in the embodiment of driving data being coolant temperature and where there is one set of raw driving data, the processing device 12 may perform prediction based on the raw driving data using the pre-trained model of transfer learning (TL), and the status prediction result generated by the pre-trained model may indicate whether the cooling performance of the coolant has decreased. When the target sub-data set is categorized to the existing cluster C3 but the status prediction result generated by the pre-trained model indicates the raw driving data, as shown in FIG. 3(b), the status prediction result generated by the pre-trained model may include abnormal points A1 and A2 located in the target sub-data set P3. Similarly, when the target sub-data set is categorized to the existing cluster C4 but the status prediction result generated by the pre-trained model indicates that the raw driving data is abnormal, as shown in FIG. 3(b), the status prediction result generated by the pre-trained model may include abnormal point A3 located in the target sub-data set P4. In other words, take the abnormal point A1 as an example, the abnormal point A1 indicates that the set of raw driving data belongs to the vehicle corresponding to the cluster label (manufacturer) of the existing cluster C3, and the coolant temperature of the vehicle is abnormal.

Further, in the embodiment of the sets of raw driving data having the cluster labels, respectively, step S107 may include inputting the sets of raw driving data along with the cluster label of each of the sets of raw driving data into the pre-trained model to obtain a plurality of predicted results corresponding to the sets of raw driving data, respectively, as the status prediction result. For example, in the embodiment of the sets of raw driving data being the driving speed and motor torque, the processing device 12 may perform prediction based on the raw driving data using the pre-trained model belonging to multi-task learning (MTL) model. A plurality of predicted results generated by the pre-trained model may respectively indicate whether the performance of throttle acceleration has decreased and whether the performance of the motor has decreased.

It should be noted that when the to-be-predicted raw driving data is data coming from a single sensor, the processing device 12 may perform prediction using the pre-trained model belonging to transfer learning (TL) model; and when the to-be-predicted raw driving data is data coming from different sensors, the processing device 12 may perform prediction using the pre-trained model belonging to multi-task learning (MTL) model. Further, when the prediction requirement is to determine whether the braking performance of the vehicle is abnormal, the sets of raw driving data may include the driving speed, motor torque and throttle acceleration etc., and the processing device 12 may perform prediction using the pre-trained model belonging to multi-task learning (MTL) model.

The vehicle status prediction system and method according to one or more embodiments of the present disclosure may enable comprehensive preventive maintenance and management of the vehicle. An alert notification may be sent when the vehicle status is abnormal, allowing the vehicle owner to be notified before issues occur and to perform preventive maintenance, thereby avoiding deterioration of failures and unexpected problem, ultimately enhancing the reliability and safety of the vehicle.

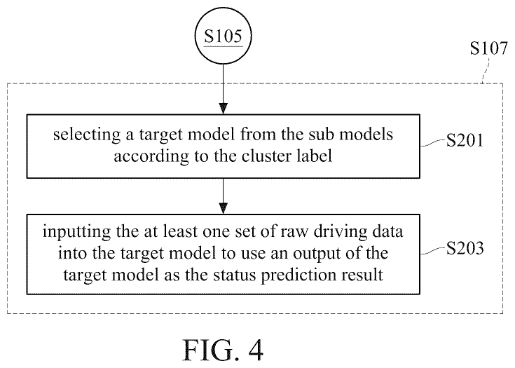

Please refer to FIG. 1 and FIG. 4, wherein FIG. 4 is a flowchart illustrating generating a status prediction result of the vehicle in the vehicle status prediction method according to an embodiment of the present disclosure. Steps shown in FIG. 4 may be performed after step S105 of FIG. 1, and FIG. 4 may be regarded as a detailed flowchart of an embodiment of step S107 of FIG. 4. In the embodiment of FIG. 4, the pre-trained model may include a plurality of sub models that are trained in advance, and the sub models may correspond to the labels of the existing clusters, respectively. The embodiment of FIG. 4 is updated to the pre-trained model implemented with transfer learning (TL). As shown in FIG. 4, generating the status prediction result of the vehicle may include: step S201: selecting a target model from the plurality of sub models according to the cluster label; and step S203: inputting the at least one set of raw driving data into the target model to use an output of the target model as the status prediction result.

In step S201, the processing device 12 may select one of the sub models corresponding to the cluster label of the target sub-data set as the target model. For example, the sub models may correspond to different manufacturers, respectively, and the sub models may all be models used for the prediction of coolant temperature. The processing device 12 may select one of the sub models with the same manufacturer indicated by the cluster label as the target model.

In step S203, the processing device 12 may input said at least one set of raw driving data into the target model to use the output of the target model as the status prediction result of the vehicle. Accordingly, the processing device 12 may select the target model suitable for the prediction on the raw driving data.

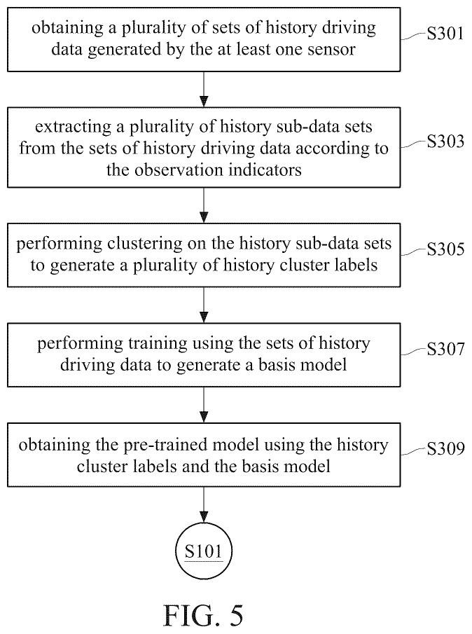

Please refer to FIG. 1 and FIG. 5, wherein FIG. 5 is a flowchart illustrating generating a pre-trained model in the vehicle status prediction method according to an embodiment of the present disclosure. As shown in FIG. 5, generating the pre-trained model may include: step S301: obtaining a plurality of sets of history driving data generated by the at least one sensor; step S303: extracting a plurality of history sub-data sets from the plurality of sets of history driving data according to the plurality of observation indicators; step S305: performing clustering on the plurality of history sub-data sets to generate a plurality of history cluster labels; step S307: performing training using the plurality of sets of history driving data to generate a basis model; and step S309: obtaining the pre-trained model using the plurality of history cluster labels and the basis model. Steps in FIG. 5 may be performed prior to step S101 of FIG. 1, or at least prior to step S107 of FIG. 1. FIG. 5 illustrates step S307 as performed after step S305, but step S307 may also be performed prior to step S305. In other words, the training of step S307 may be performed as long as the history driving data is obtained through step S301. In the present embodiment, steps of FIG. 5 are performed by the processing device 12, but in other embodiments, steps of FIG. 5 are performed by another processing device, and the processing device 12 may receive the generated pre-trained model from said another processing device.

The implementations of step S301 and step S303 may be the same as step S101 and step S103 of FIG. 2, respectively, the time point of the generation of the history driving data of step S301 and step S303 is earlier than that of the raw driving data of step S101 and step S103. Further, in step S303, each of the sets of history driving data is extracted according to the observation indicators to obtain the history sub-data sets of each of the sets of history driving data. The implementations of step S301 and step S303 are not repeated herein.

In step S305, the processing device 12 may cluster the history sub-data sets to generate the history labels, and the processing device 12 may perform DBSCAN algorithm on the history sub-data sets to generate the existing clusters, and use the labels of the existing clusters as the history labels of the history sub-data sets, respectively. In other words, the history labels may be used as the labels of the existing clusters described in step S105 of FIG. 2.

In step S307, the processing device 12 may perform training using the sets of history driving data to generate the basis model. The basis model may be a transformer model, and may be used as a neural network shared at the base layer of the neural network model.

In step S309, the processing device 12 may obtain the pre-trained model using the history labels and the basis model. In an embodiment, step S309 may include fine-tuning the basis model using the history labels, respectively, to generate the sub models as the pre-trained model. In other words, in the embodiment where the pre-trained model is a transfer learning model, the processing device 12 may perform training to generate the basis model, and then fine tune the basis model based on each of the history labels to generate the sub models corresponding to the history labels, respectively. In another embodiment, step S309 may include setting a plurality of specified layers and a plurality of shared layer of the basis model using the history labels, respectively, to generate the pre-trained model. In other words, in the embodiment where the pre-trained model is a multitask learning model, the processing device 12 may perform training to generate the basis model as the neural network shared at the base layer, and then set a corresponding output for each of the history labels.

In an embodiment, the history driving data is data generated by a sensor of the same brand performing sensing on vehicles of different manufacturers, and the history label may indicate the vehicle manufacturer corresponding to the history sub-data set. In another embodiment, the history driving data is data generated by the same type of sensors of different brands, and the history label may indicate the brand of the sensor corresponding to the history sub-data set. In yet another embodiment, the history driving data is data generated by various sensors (for example, driving speed sensor and motor torque sensor as described above) performing sensing on vehicles of different manufacturers, and the history label may indicate the vehicle manufacturer corresponding to the history sub-data set.

In addition, the vehicle status prediction system and method according to one or more embodiments of the present disclosure may further include re-clustering all raw driving data and history driving data at predetermined time interval to update the cluster labels of the existing clusters.

In view of the above description, the vehicle status prediction system and method according to one or more embodiments of the present disclosure may enable comprehensive preventive maintenance and management of the vehicle. An alert notification may be sent when the vehicle status is abnormal, allowing the vehicle owner to be notified before issues occur and to perform preventive maintenance, thereby avoiding deterioration of failures and unexpected problem, ultimately enhancing the reliability and safety of the vehicle. Further, by selecting the target model according to the cluster label, the processing device may select the target model suitable for the prediction on the raw driving data.

What is claimed is:

1. A vehicle status prediction method, adapted to a vehicle installed with at least one sensor, performed by a processing device and comprising:
obtaining at least one set of raw driving data from the at least one sensor;
extracting at least one target sub-data set from the at least one set of raw driving data according to a plurality of observation indicators;
clustering the at least one target sub-data set to generate a cluster label; and
performing prediction on the at least one set of raw driving data according to the cluster label using a pre-trained model to generate a status prediction result of the vehicle.

2. The vehicle status prediction method according to claim 1, wherein the pre-trained model comprises a plurality of sub models, and performing the prediction on the at least one set of raw driving data according to the cluster label using the pre-trained model to generate the status prediction result of the vehicle comprises:
selecting a target model from the plurality of sub models according to the cluster label; and
inputting the at least one set of raw driving data into the target model to use an output of the target model as the status prediction result.

3. The vehicle status prediction method according to claim 1, wherein the at least one sensor is a plurality of sensors, the at least one set of raw driving data is a plurality of sets of raw driving data, the at least one target sub-data set is a plurality of target sub-data sets, and performing clustering on the at least one target sub-data set to generate the cluster label comprises:
clustering the plurality of target sub-data sets to generate the cluster label of each of the plurality of sets of raw driving data.

4. The vehicle status prediction method according to claim 3, wherein performing the prediction on the at least one set of raw driving data according to the cluster label using the pre-trained model to generate the status prediction result of the vehicle comprises:
inputting the plurality of sets of raw driving data and the cluster label of each of the plurality of sets of raw driving data into the pre-trained model to obtain a plurality of predicted results corresponding to the plurality of sets of raw driving data, respectively, as the status prediction result.

5. The vehicle status prediction method according to claim 1, wherein the vehicle is connected to a charging station, and obtaining the at least one set of raw driving data from the at least one sensor comprises:
receiving the at least one set of raw driving data through the charging station.

6. The vehicle status prediction method according to claim 1, further comprising:
obtaining a plurality of sets of history driving data generated by the at least one sensor;
extracting a plurality of history sub-data sets from the plurality of sets of history driving data according to the plurality of observation indicators;
performing clustering on the plurality of history sub-data sets to generate a plurality of history cluster labels;
performing training using the plurality of sets of history driving data to generate a basis model; and
obtaining the pre-trained model using the plurality of history cluster labels and the basis model.

7. The vehicle status prediction method according to claim 6, wherein obtaining the pre-trained model using the plurality of history cluster labels and the basis model comprises:
fine-tuning the basis model using the plurality of history cluster labels, respectively, to generate a plurality of sub models as the pre-trained model.

8. The vehicle status prediction method according to claim 6, wherein obtaining the pre-trained model using the plurality of history cluster labels and the basis model comprises:
setting a plurality of specified layers and a plurality of shared layers of the basis model using the plurality of history cluster labels, respectively, to generate the pre-trained model.

9. The vehicle status prediction method according to claim 1, wherein performing clustering on the at least one target sub-data set to generate the cluster label comprises:
executing a density-based spatial clustering of application with noise algorithm on the at least one target sub-data set to generate the cluster label.

10. A vehicle status prediction system, adapted to a vehicle installed with at least one sensor, comprising:
a memory device configured to store a pre-trained model; and
a processing device connected to the memory device and configured to perform:
obtaining at least one set of raw driving data from the at least one sensor;
extracting at least one target sub-data set from the at least one set of raw driving data according to a plurality of observation indicators;
clustering the at least one target sub-data set to generate a cluster label; and
performing prediction on the at least one set of raw driving data according to the cluster label using the pre-trained model to generate a status prediction result of the vehicle.

11. The vehicle status prediction system according to claim 10, wherein the pre-trained model comprises a plurality of sub models, and the processing device is configured to select a target model from the plurality of sub models according to the cluster label, and input the at least one set of raw driving data into the target model to use an output of the target model as the status prediction result.

12. The vehicle status prediction system according to claim 10, wherein the at least one sensor is a plurality of sensors, the at least one set of raw driving data is a plurality of sets of raw driving data, the at least one target sub-data set is a plurality of target sub-data sets, and the processing device is configured to cluster the plurality of target sub-data sets to generate the cluster label of each of the plurality of sets of raw driving data.

13. The vehicle status prediction system according to claim 12, wherein the processing device is configured to input the plurality of sets of raw driving data and the cluster label of each of the plurality of sets of raw driving data into the pre-trained model to obtain a plurality of predicted results corresponding to the plurality of sets of raw driving data, respectively, as the status prediction result.

14. The vehicle status prediction system according to claim 10, wherein the processing device is configured to receive the at least one set of raw driving data through a charging station.

15. The vehicle status prediction system according to claim 10, wherein the processing device is further configured to obtain a plurality of sets of history driving data generated by the at least one sensor, extract a plurality of history sub-data sets from the plurality of sets of history driving data according to the plurality of observation indicators, perform clustering on the plurality of history sub-data sets to generate a plurality of history cluster labels, perform training using the plurality of sets of history driving data to generate a basis model, and obtain the pre-trained model using the plurality of history cluster labels and the basis model.

16. The vehicle status prediction system according to claim 15, wherein the processing device is configured to fine-tune the basis model using the plurality of history cluster labels, respectively, to generate a plurality of sub models as the pre-trained model.

17. The vehicle status prediction system according to claim 15, wherein the processing device is configured to set a plurality of specified layers and a plurality of shared layers of the basis model using the plurality of history cluster labels, respectively, to generate the pre-trained model.

18. The vehicle status prediction system according to claim 10, wherein the processing device is configured to execute a density-based spatial clustering of application with noise algorithm on the at least one target sub-data set to generate the cluster label.
